(19) United States
(12) Patent Application Publication
(10) Pub. No.: US 2026/0004594 A1
(43) Pub. Date: Jan. 1, 2026

(54) INFORMATION PROCESSING DEVICE, INFORMATION PROCESSING METHOD, AND INFORMATION PROCESSING SYSTEM

(71) Applicant: Sony Semiconductor Solutions Corporation, Kanagawa (JP)

(72) Inventors: Tatsuya Sakashita, Kanagawa (JP); Takashi Nakanishi, Tokyo (JP); Takuma Aoyama, Kanagawa (JP)

(21) Appl. No.: 18/880,657

(22) PCT Filed: Jul. 10, 2023
(86) PCT No.: PCT/JP23/25405

§ 371 Date: Jan. 2, 2025

(30) Foreign Application Priority Data
Jul. 28, 2022 (JP) 2022-120203

(51) Int. Cl. G06V 20/58; G06V 10/12; G06V 10/82

(52) U.S. Cl. CPC G06V 20/58; G06V 10/12; G06V 10/82

(57) ABSTRACT

Power consumption reduction in object recognition processing using sensor fusion processing is disclosed. In one example, an information processing device includes an object recognition unit configured to combine sensing data pieces from multiple types of sensors that perform sensing around a vehicle and perform object recognition processing, a contribution ratio calculation unit configured to calculate a contribution ratio of each of the sensing data pieces in the recognition processing, and a recognition processing control unit configured to restrict the sensing data pieces to be used for the recognition processing on the basis of the contribution ratio. The technology can be applied, for example, to vehicles.

### TECHNICAL FIELD

The present technology relates to an information processing device, an information processing method, and an information processing system, and more particularly, to an information processing device, an information processing method, and an information processing system suitable for use in sensor fusion processing.

### BACKGROUND ART

Proposals have been made to improve object recognition accuracy in vehicles having automated driving functions by using sensor fusion processing (for example, see PTL 1).

### CITATION LIST

### Patent Literature

[PTL 1]

WO 2020/116195

### SUMMARY

### Technical Problem

Meanwhile, reducing power consumption is crucial in electric vehicles having automated driving functions. More specifically, reducing power consumption and extending the driving distance of electric vehicles allow for improvements in convenience and global environmental protection.

However, when sensor fusion processing is used to improve object recognition accuracy, the power consumption by sensing processing and recognition processing (especially deep learning processing) increases, and the driving distance may be reduced as a result.

The present technology has been developed in view of the foregoing and is directed to reduction in power consumption by object recognition processing using sensor fusion processing.

### Solution to Problem

An information processing device according to a first aspect of the present technology includes: an object recognition unit configured to combine sensing data pieces from multiple types of sensors so as to perform sensing around a vehicle and perform object recognition processing; a contribution ratio calculation unit configured to calculate a contribution ratio of each of the sensing data pieces in the recognition processing; and a recognition processing control unit configured to restrict the sensing data pieces to be used for the recognition processing on the basis of the contribution ratio.

An image processing method according to the first aspect of the present technology includes: combining sensing data pieces from multiple types of sensors that perform sensing around a vehicle, thereby performing object recognition processing: calculating a contribution ratio of each of the sensing data pieces in the recognition processing: and restricting the sensing data pieces to be used for the recognition processing on the basis of the contribution ratio.

An information processing system according to a second aspect of the present technology includes: multiple types of sensors configured to perform sensing around a vehicle; an object recognition unit configured to combine sensing data pieces from the respective sensors so as to perform object recognition processing: a contribution ratio calculation unit configured to calculate a contribution ratio of each of the sensing data pieces to the recognition processing: and a recognition processing control unit configured to restrict the sensing data pieces to be used for the recognition processing on the basis of the contribution ratio.

According to the first aspect of the present technology, sensing data pieces from multiple types of sensors are combined to perform object recognition processing, a contribution ratio of each of the sensing data pieces to the recognition processing is calculated, and the sensing data pieces to be used for the recognition processing are restricted on the basis of the contribution ratio.

According to the second aspect of the present technology, multiple types of sensors are configured to perform sensing around a vehicle, sensing data pieces from the sensors are combined to perform object recognition processing, a contribution ratio of each of the sensing data pieces to the recognition processing is calculated, and the sensing data pieces to be used for the recognition processing are restricted on the basis of the contribution ratio.

### BRIEF DESCRIPTION OF DRAWINGS

FIG. 1 is a block diagram of a configuration example of a vehicle control system.

FIG. 2 illustrates an example of sensing areas.

FIG. 3 is a block diagram of a configuration example of an information processing system to which the present technology is applied.

FIG. 4 is a diagram of a configuration example of an object recognition model.

FIG. 5 is a flowchart for illustrating object recognition processing according to a first embodiment.

FIG. 6 is a view for illustrating an example of how the resolution of captured image data for recognition is lowered.

FIG. 7 is a view for illustrating an example of how to restrict an area of captured image data for recognition to be subjected to recognition processing.

FIG. 8 is a timing chart for illustrating an example of timing for checking the contribution ratios of all sensing data pieces to recognition processing.

FIG. 9 is a flowchart for illustrating object recognition processing according to a second embodiment.

FIG. 10 is a block diagram of a configuration example of a computer.

### DESCRIPTION OF EMBODIMENTS

Hereinafter, modes for carrying out the present technology will be described.

The description will be made in the following order.
1. Configuration example of vehicle control system
2. Embodiments
3. Modifications
4. Others

### 1. Configuration Example of Vehicle Control System

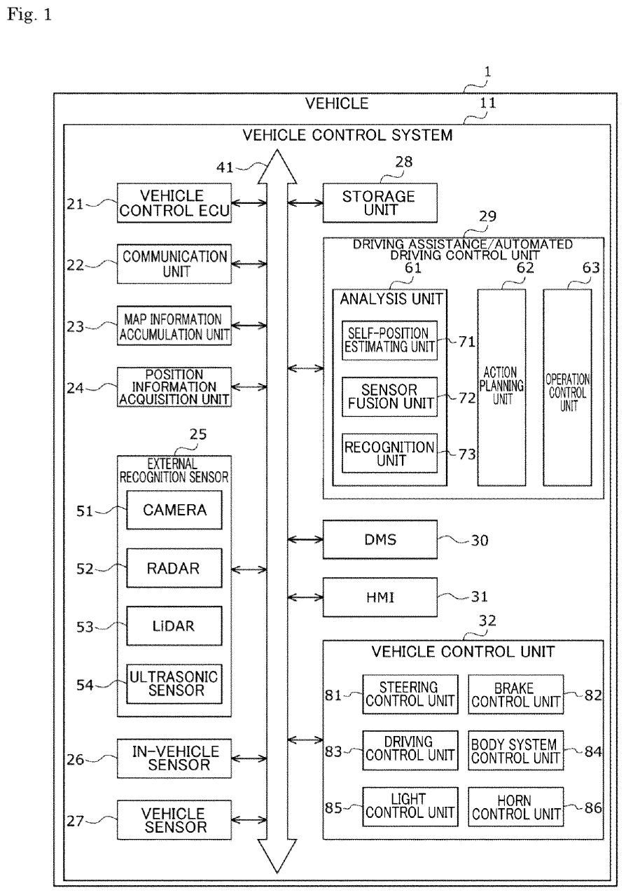

FIG. 1 is a block diagram of a configuration example of a vehicle control system 11 as an example of a mobile apparatus control system to which the present technology is applied.

The vehicle control system 11 is provided in a vehicle 1 and performs processing related to driving assistance and automated driving of the vehicle 1.

The vehicle control system 11 includes a vehicle control ECU (Electronic Control Unit) 21, a communication unit 22, a map information accumulation unit 23, a position information acquisition unit 24, an external recognition sensor 25, an in-vehicle sensor 26, a vehicle sensor 27, a storage unit 28, a driving assistance/automated driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the driving assistance/automated driving control unit 29, the driver monitoring system (DMS) 30, the human machine interface (HMI) 31, and the vehicle control unit 32 are connected to each other via a communication network 41 so that they can communicate with each other. The communication network 41 is configured by a vehicle-mounted network compliant with digital two-way communication standards such as CAN (Controller Area Network), LIN (Local Interconnect Network), LAN (Local Area Network), FlexRay (registered trademark), and Ethernet (registered trademark), a bus, and the like. The communication network 41 may be used differently depending on the type of data to be transmitted. For example, CAN may be applied to data related to vehicle control, and Ethernet may be applied to large-capacity data. Note that each unit of the vehicle control system 11 may be directly connected using wireless communication that assumes communication over a relatively short distance, such as near field communication (NFC) or Bluetooth (registered trademark) without involving the communication network 41.

In the following description, the description of the communication network 41 will be omitted when the various parts of the vehicle control system 11 communicate over the communication network 41. For example, when the vehicle control ECU 21 and the communication unit 22 perform communication via the communication network 41, it is simply stated that the vehicle control ECU 21 and the communication unit 22 perform communication.

The vehicle control ECU 21 is composed of, for example, various processors such as a CPU (Central Processing Unit) and an MPU (Micro Processing Unit). The vehicle control ECU 21 controls the entire or part of the functions of the vehicle control system 11.

The communication unit 22 communicates with various devices inside and outside the vehicle, other vehicles, servers, base stations, and the like and performs transmission/reception of various kinds of data. At the time, the communication unit 22 can perform communication using a plurality of communication methods.

Communication with the outside of the vehicle that can be performed by the communication unit 22 will be described schematically. The communication unit 22 communicates with a server or the like that is present on an external network (hereinafter referred to as an external server) according to a wireless communication method such as 5G (5th Generation Mobile Communication System), LTE (Long Term Evolution), or DSRC (Dedicated Short Range Communications) via a base station or an access point. The external network with which the communication unit 22 communicates is, for example, the Internet, a cloud network, or a business-specific network. The communication method according to which the communication unit 22 performs communication with the external network is not particularly limited as long as it is a wireless communication method that enables digital two-way communication at a communication speed of a predetermined value or more and a distance of a predetermined value or more.

Furthermore, for example, the communication unit 22 can communicate with a terminal located near the host vehicle using P2P (Peer To Peer) technology. Terminals that exist near the host vehicle include, for example, terminals worn by moving objects that move at relatively low speeds such as pedestrians and bicycles, terminals that are installed at fixed locations in stores, or MTC (Machine Type Communication) terminals. Furthermore, the communication unit 22 can also perform V2X communication. V2X communication refers to communication between the host vehicle and another vehicle, for example, vehicle-to-vehicle communication with another vehicle, vehicle-to-infrastructure communication with roadside devices or the like, vehicle-to-home communication with home, and vehicle-to-pedestrian communication with terminals owned by pedestrians or the like.

The communication unit 22 can receive, for example, a program for updating software that controls the operation of the vehicle control system 11 from the outside (over the air). The communication unit 22 can further receive map information, traffic information, information around the vehicle 1, and the like from the outside. Further, for example, the communication unit 22 can transmit information regarding the vehicle 1, information around the vehicle 1, and the like to the outside. The information regarding the vehicle 1 that the communication unit 22 transmits to the outside includes, for example, data indicating the state of the vehicle 1, recognition results obtained by the recognition unit 73, and the like. For example, the communication unit 22 performs communication accommodating vehicle emergency notification systems such as eCall.

For example, the communication unit 22 receives electromagnetic waves transmitted by a Vehicle Information and Communication System (VICS (registered trademark)) using a radio beacon, a light beacon, FM multiplex broadcast, and the like.

Communication with the inside of the vehicle that can be performed by the communication unit 22 will be described schematically. The communication unit 22 can communicate with each device in the vehicle using, for example, wireless communication. The communication unit 22 can perform wireless communication with devices in the vehicle using a communication method such as wireless LAN, Bluetooth, NFC, and WUSB (Wireless USB) that enables digital two-way communication at a communication speed of a predetermined value or more. Not limited to this, the communication unit 22 can also communicate with each device in the vehicle using wired communication. For example, the communication unit 22 can communicate with each device in the vehicle by wired communication via a cable connected to a connection terminal (not shown). The communication unit 22 can communicate with each device in the vehicle according to a communication method such as USB (Universal Serial Bus), HDMI (High-Definition Multimedia Interface) (registered trademark), and MHL (Mobile High-definition Link) that enables digital two-way communication at a communication speed of predetermined value or more by wired communication.

In this case, a device in the vehicle refers to, for example, a device not connected to the communication network 41 in the vehicle. Examples of devices in the vehicle include a mobile device or a wearable device carried by an occupant such as a driver or an information device which is carried aboard the vehicle to be temporarily installed therein.

The map information accumulation unit 23 accumulates one or both of maps acquired from the outside and maps created by the vehicle 1. For example, the map information accumulation unit 23 accumulates a three-dimensional high-precision map, a global map which is less precise than the high-precision map but which covers a wide area, and the like.

The high-precision map is, for example, a dynamic map, a point cloud map, a vector map, or the like. A dynamic map is a map which is composed of four layers of dynamic information, quasi-dynamic information, quasi-static information, and static information and which is provided to the vehicle 1 by an external server or the like. A point cloud map is a map composed of a point cloud (point cloud data). A vector map is, for example, a map adapted to ADAS (Advanced Driver Assistance System) and AD (Autonomous Driving) by associating traffic information such as lanes and positions of traffic lights with a point cloud map.

For example, the point cloud map and the vector map may be provided by an external server or the like or created by the vehicle 1 as a map to be matched with a local map (to be described later) based on sensing results by a camera 51, a radar 52, a LiDAR 53 or the like and accumulated in the map information accumulation unit 23. In addition, when a high-precision map is to be provided by an external server or the like, in order to reduce communication capacity, map data of, for example, a square with several hundred meters per side regarding a planned path to be traveled by the vehicle 1 is acquired from the external server or the like.

The position information acquisition unit 24 receives GNSS signals from GNSS (Global Navigation Satellite System) satellites and acquires position information of the vehicle 1. The acquired position information is supplied to the driving assistance/automated driving control unit 29. Note that the position information acquisition unit 24 is not limited to the method using GNSS signals, and may acquire position information using beacons, for example.

The external recognition sensor 25 includes various sensors used to recognize a situation outside of the vehicle 1 and supplies each unit of the vehicle control system 11 with sensor data from each sensor. The external recognition sensor 25 may include any type of or any number of sensors.

For example, the external recognition sensor 25 includes the camera 51, the radar 52, the LiDAR (Light Detection and Ranging, Laser Imaging Detection and Ranging) 53, and an ultrasonic sensor 54. The configuration is not limited to this, and the external recognition sensor 25 may include one or more types of sensors among the camera 51, the radar 52, the LiDAR 53, and the ultrasonic sensor 54. The number of cameras 51, radars 52, LiDAR 53, and ultrasonic sensors 54 is not particularly limited as long as it can be realistically installed in the vehicle 1. Further, the types of sensors included in the external recognition sensor 25 are not limited to this example, and the external recognition sensor 25 may include other types of sensors. Examples of sensing areas of each sensor included in the external recognition sensor 25 will be described later.

Note that the imaging method of the camera 51 is not particularly limited. For example, cameras of various types such as a ToF (Time Of Flight) camera, a stereo camera, a monocular camera, and an infrared camera, which are capable of distance measurement, can be applied to the camera 51 as necessary. The camera 51 is not limited to this, and may simply acquire a photographed image regardless of distance measurement.

In addition, for example, the external recognition sensor 25 can include an environment sensor for detecting the environment with respect to the vehicle 1. The environment sensor is a sensor for detecting the environment such as weather, climate, brightness, and the like, and can include various sensors such as raindrop sensors, fog sensors, sunshine sensors, snow sensors, and illuminance sensors.

Furthermore, for example, the external recognition sensor 25 includes a microphone to be used to detect sound around the vehicle 1, a position of a sound source, or the like.

The in-vehicle sensor 26 includes various sensors for detecting information inside the vehicle and supplies each unit of the vehicle control system 11 with sensor data from each sensor. The types and number of various sensors included in the in-vehicle sensor 26 are not particularly limited as long as they are the types and number that can be realistically installed in the vehicle 1.

For example, the in-vehicle sensor 26 can include one or more types of sensors among a camera, a radar, a seating sensor, a steering wheel sensor, a microphone, and a biological sensor. As the camera included in the in-vehicle sensor 26, it is possible to use cameras of various photographing methods capable of measuring distance, such as a ToF camera, a stereo camera, a monocular camera, and an infrared camera. However, the present invention is not limited to this, and the camera included in the in-vehicle sensor 26 may simply be used to acquire photographed images, regardless of distance measurement. The biosensor included in the in-vehicle sensor 26 is provided, for example, in a seat or a steering wheel, and detects various types of biological information of a passenger such as a driver.

The vehicle sensor 27 includes various sensors for detecting a state of the vehicle 1 and supplies each unit of the vehicle control system 11 with sensor data from each sensor. The types and number of various sensors included in the vehicle sensor 27 are not particularly limited as long as they can be realistically installed in the vehicle 1.

For example, the vehicle sensor 27 includes a velocity sensor, an acceleration sensor, an angular velocity sensor (gyroscope sensor), and an inertial measurement unit (IMU) that integrates these sensors. For example, the vehicle sensor 27 includes a steering angle sensor which detects a steering angle of the steering wheel, a yaw rate sensor, an accelerator sensor which detects an operation amount of the accelerator pedal, and a brake sensor which detects an operation amount of the brake pedal. For example, the vehicle sensor 27 includes a rotation sensor which detects a rotational speed of an engine or a motor, an air pressure sensor which detects air pressure of a tire, a slip ratio sensor which detects a slip ratio of a tire, and a wheel speed sensor which detects a rotational speed of a wheel. For example, the vehicle sensor 27 includes a battery sensor which detects remaining battery life and temperature of a battery and an impact sensor which detects an impact from the outside.

The storage unit 28 includes at least one of a nonvolatile storage medium and a volatile storage medium, and stores data and programs. The storage unit 28 is used, for example, as an EEPROM (Electrically Erasable Programmable Read Only Memory) and a RAM (Random Access Memory). As a storage medium, a magnetic storage device such as an HDD (Hard Disc Drive), a semiconductor storage device, an optical storage device, and a magneto optical storage device can be applied. The storage unit 28 stores various programs and data used by each unit of the vehicle control system 11. For example, the storage unit 28 includes an EDR (Event Data Recorder) and a DSSAD (Data Storage System for Automated Driving), and stores information on the vehicle 1 and information acquired by the in-vehicle sensor 26 before and after an event such as an accident.

The driving assistance/automated driving control unit 29 controls driving assistance and automated driving of the vehicle 1. For example, the driving assistance/automated driving control unit 29 includes an analyzing unit 61, an action planning unit 62, and an operation control unit 63.

The analyzing unit 61 performs analysis processing of the vehicle 1 and its surroundings. The analyzing unit 61 includes a self-position estimating unit 71, a sensor fusion unit 72, and the recognition unit 73.

The self-position estimating unit 71 estimates a self-position of the vehicle 1 based on sensor data from the external recognition sensor 25 and the high-precision map accumulated in the map information accumulation unit 23. For example, the self-position estimating unit 71 estimates a self-position of the vehicle 1 by generating a local map based on sensor data from the external recognition sensor 25 and matching the local map and the high-precision map with each other. A position of the vehicle 1 is based on, for example, a center of the rear axle.

The local map is, for example, a three-dimensional high precision map, an occupancy grid map, or the like created using a technique such as SLAM (Simultaneous Localization and Mapping). An example of a three-dimensional high-precision map is the point cloud map described above. An occupancy grid map is a map which is created by dividing a three-dimensional or two-dimensional space around the vehicle 1 into grids of a predetermined size and which indicates an occupancy of an object in grid units. The occupancy of an object is represented by, for example, a presence or an absence of the object or an existence probability of the object. The local map is also used in, for example, detection processing and recognition processing of surroundings of the vehicle 1 by the recognition unit 73.

Note that the self-position estimating unit 71 may estimate the self-position of the vehicle 1 based on the position information acquired by the position information acquisition unit 24 and sensor data from the vehicle sensor 27.

The sensor fusion unit 72 performs sensor fusion processing for obtaining new information by combining sensor data of a plurality of different types (for example, image data supplied from the camera 51 and sensor data supplied from the radar 52). Methods of combining sensor data of a plurality of different types include integration, fusion, and association.

The recognition unit 73 performs detection processing for detecting the situation outside of the vehicle 1 and recognition processing for recognizing the situation outside of the vehicle 1.

For example, the recognition unit 73 performs detection processing and recognition processing of surroundings of the vehicle 1 based on information from the external recognition sensor 25, information from the self-position estimating unit 71, information from the sensor fusion unit 72, and the like.

Specifically, for example, the recognition unit 73 performs detection processing, recognition processing, and the like of an object in the periphery of the vehicle 1. The detection processing of an object refers to, for example, processing for detecting the presence or absence, a size, a shape, a position, a motion, or the like of an object. The recognition processing of an object refers to, for example, processing for recognizing an attribute such as a type of an object or identifying a specific object. However, a distinction between detection processing and recognition processing is not always obvious and an overlap may sometimes occur.

For example, the recognition unit 73 detects objects around the vehicle 1 by performing clustering to classify point clouds based on sensor data from the radar 52, the LiDAR 53, and the like for each cluster of point clouds. Accordingly, the presence or absence, a size, a shape, and a position of an object around the vehicle 1 are detected.

For example, the recognition unit 73 detects a motion of the object around the vehicle 1 by performing tracking to track a motion of a cluster of point clouds classified by clustering. Accordingly, a speed and traveling direction (a motion vector) of the object around the vehicle 1 are detected.

For example, the recognition unit 73 detects or recognizes vehicles, people, bicycles, obstacles, structures, roads, traffic lights, traffic signs, road markings, and the like based on the image data supplied from the camera 51. Further, the recognition unit 73 may recognize the types of objects around the vehicle 1 by performing recognition processing such as semantic segmentation.

For example, the recognition unit 73 can perform recognition processing of traffic rules around the vehicle 1 based on the map stored in the map information accumulation unit 23, the self-position estimation result obtained by the self-position estimating unit 71, and the recognition result of objects around the vehicle 1 obtained by the recognition unit 73. Through this processing, the recognition unit 73 can recognize the positions and states of traffic lights, the contents of traffic signs and road markings, the contents of traffic regulations, the lanes in which the vehicle can travel, and the like.

For example, the recognition unit 73 can perform recognition processing of the environment around the vehicle 1. The surrounding environment to be recognized by the recognition unit 73 includes weather, temperature, humidity, brightness, road surface conditions, and the like.

The action planning unit 62 creates an action plan of the vehicle 1. For example, the action planning unit 62 creates an action plan by performing processing of path planning and path following.

Path planning (Global path planning) is processing of planning a general path from start to goal. Path planning also includes processing of trajectory generation (local path planning) which is referred to as trajectory planning and which enables safe and smooth travel in the vicinity of the vehicle 1 in consideration of motion characteristics of the vehicle 1 along a planned path.

Path following refers to processing of planning an operation for safely and accurately traveling the path planned by path planning within a planned time. The action planning unit 62 can calculate the target speed and target angular velocity of the vehicle 1, for example, based on the result of this route following process.

The operation control unit 63 controls operations of the vehicle 1 in order to realize the action plan created by the action planning unit 62.

For example, the operation control unit 63 controls a steering control unit 81, a brake control unit 82, and a drive control unit 83, which are included in a vehicle control unit 32 described later, to perform acceleration/deceleration control and directional control so that the vehicle 1 proceeds along a trajectory calculated by trajectory planning. For example, the operation control unit 63 performs cooperative control in order to realize functions of ADAS such as collision avoidance or shock mitigation, car-following driving, constant-speed driving, collision warning of own vehicle, and lane deviation warning of own vehicle. For example, the operation control unit 63 performs cooperative control in order to realize automated driving or the like in which a vehicle autonomously travels irrespective of manipulations by a driver.

The DMS 30 performs authentication processing of a driver, recognition processing of a state of the driver, and the like based on sensor data from the in-vehicle sensor 26, input data that is input to the HMI 31 described later, and the like. As a state of the driver to be a recognition target, for example, a physical condition, a level of arousal, a level of concentration, a level of fatigue, an eye gaze direction, a level of intoxication, a driving operation, or a posture is assumed.

Alternatively, the DMS 30 may be configured to perform authentication processing of an occupant other than the driver and recognition processing of a state of such an occupant. In addition, for example, the DMS 30 may be configured to perform recognition processing of a situation inside the vehicle based on sensor data from the in-vehicle sensor 26. As the situation inside the vehicle to be a recognition target, for example, temperature, humidity, brightness, or odor is assumed.

The HMI 31 inputs various pieces of data and instructions, and presents various pieces of data to the driver and the like.

Data input by the HMI 31 will be briefly described. The HMI 31 includes an input device for a person to input data. The HMI 31 generates input signals based on data, instructions, and the like input by an input device, and supplies them to each unit of the vehicle control system 11. The HMI 31 includes operators such as a touch panel, buttons, switches, and levers as input devices. However, the present invention is not limited to this, and the HMI 31 may further include an input device capable of inputting information by a method other than manual operation using voice, gesture, or the like. Further, the HMI 31 may use, as an input device, an externally connected device such as a remote control device using infrared rays or radio waves, a mobile device or a wearable device compatible with the operation of the vehicle control system 11, for example.

Presentation of data by the HMI 31 will be briefly described. The HMI 31 generates visual information, auditory information, and tactile information for the passenger or the outside of the vehicle. Furthermore, the HMI 31 performs output control to control the output, output content, output timing, output method, and the like of each piece of generated information. The HMI 31 generates and outputs, as visual information, information indicated by images and light, such as an operation screen, a status display of the vehicle 1, a warning display, and a monitor image showing the surrounding situation of the vehicle 1, for example. Furthermore, the HMI 31 generates and outputs, as auditory information, information indicated by sounds such as audio guidance, warning sounds, and warning messages. Furthermore, the HMI 31 generates and outputs, as tactile information, information given to the passenger's tactile sense by, for example, force, vibration, movement, or the like.

As an output device for the HMI 31 to output visual information, for example, a display device that presents visual information by displaying an image or a projector device that presents visual information by projecting an image can be applied. In addition to display devices that have a normal display, the display device may be a display device that displays visual information within the passenger's field of view such as, for example, a head-up display, a transparent display, and a wearable device with an AR (Augmented Reality) function. Further, the HMI 31 can also use a display device included in a navigation device, an instrument panel, a CMS (Camera Monitoring System), an electronic mirror, a lamp, and the like provided in the vehicle 1 as an output device that outputs visual information.

As an output device for the HMI 31 to output auditory information, for example, an audio speaker, headphones, or earphones can be applied.

As an output device for the HMI 31 to output tactile information, for example, a haptics element using a haptics technology can be applied. The haptics element is provided in a portion of the vehicle 1 that comes into contact with a passenger, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including the steering wheel and the like, electronic power steering, and the like. For example, the steering control unit 81 includes a steering ECU which controls the steering system, an actuator which drives the steering system, and the like.

The brake control unit 82 performs detection, control, and the like of a state of a brake system of the vehicle 1. For example, the brake system includes a brake mechanism including a brake pedal and the like, an ABS (Antilock Brake System), a regenerative brake mechanism, and the like. For example, the brake control unit 82 includes a brake ECU which controls the brake system, an actuator which drives the brake system, and the like.

The drive control unit 83 performs detection, control, and the like of a state of a drive system of the vehicle 1. For example, the drive system includes an accelerator pedal, a drive force generating apparatus for generating a drive force such as an internal combustion engine or a drive motor, a drive force transmission mechanism for transmitting the drive force to the wheels, and the like. For example, the drive control unit 83 includes a drive ECU which controls the drive system, an actuator which drives the drive system, and the like.

The body system control unit 84 performs detection, control, and the like of a state of a body system of the vehicle 1. For example, the body system includes a keyless entry system, a smart key system, a power window apparatus, a power seat, an air conditioner, an airbag, a seatbelt, and a shift lever. For example, the body system control unit 84 includes a body system ECU which controls the body system, an actuator which drives the body system, and the like.

The light control unit 85 performs detection, control, and the like of a state of various lights of the vehicle 1. As lights to be a control target, for example, a headlamp, a tail lamp, a fog lamp, a turn signal, a brake lamp, a projector lamp, and a bumper display are assumed. The light control unit 85 includes a light ECU which controls the lights, an actuator which drives the lights, and the like.

The horn control unit 86 performs detection, control, and the like of a state of a car horn of the vehicle 1. For example, the horn control unit 86 includes a horn ECU which controls the car horn, an actuator which drives the car horn, and the like.

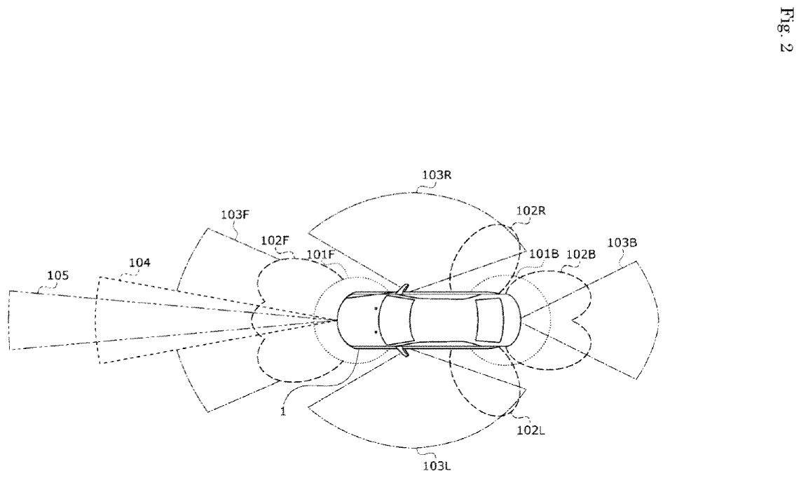

FIG. 2 is a diagram showing an example of a sensing area by the camera 51, the radar 52, the LiDAR 53, the ultrasonic sensor 54, and the like of the external recognition sensor 25 in FIG. 1. Note that FIG. 2 schematically shows the vehicle 1 viewed from above, with the left end side being the front end (front) side of the vehicle 1, and the right end side being the rear end (rear) side of the vehicle 1.

A sensing area 101F and a sensing area 101B represent an example of sensing areas of the ultrasonic sensor 54. The sensing area 101F covers the region around the front end of the vehicle 1 by a plurality of ultrasonic sensors 54. The sensing area 101B covers the region around the rear end of the vehicle 1 by a plurality of ultrasonic sensors 54.

Sensing results in the sensing area 101F and the sensing area 101B are used to provide the vehicle 1 with parking assistance or the like.

A sensing area 102F to a sensing area 102B represent an example of sensing areas of the radar 52 for short or intermediate distances. The sensing area 102F covers up to a position farther than the sensing area 101F in front of the vehicle 1. The sensing area 102B covers up to a position farther than the sensing area 101B to the rear of the vehicle 1. The sensing area 102L covers a periphery toward the rear of a left-side surface of the vehicle 1. The sensing area 102R covers a periphery toward the rear of a right-side surface of the vehicle 1.

A sensing result in the sensing area 102F is used to detect, for example, a vehicle, a pedestrian, or the like present in front of the vehicle 1. A sensing result in the sensing area 102B is used by, for example, a function of preventing a collision to the rear of the vehicle 1. Sensing results in the sensing area 102L and the sensing area 102R are used to detect, for example, an object present in a blind spot to the sides of the vehicle 1.

A sensing area 103F to a sensing area 103B represent an example of sensing areas by the camera 51. The sensing area 103F covers up to a position farther than the sensing area 102F in front of the vehicle 1. The sensing area 103B covers a position farther than the sensing area 102B behind the vehicle 1. The sensing area 103L covers a periphery of the left-side surface of the vehicle 1. The sensing area 103R covers a periphery of the right side surface of the vehicle 1.

For example, a sensing result in the sensing area 103F can be used to recognize a traffic light or a traffic sign, and can be used by a lane deviation prevention support system, and an automatic headlight control system. A sensing result in the sensing area 103B can be used for parking assistance and a surround view system, for example. Sensing results in the sensing area 103L and the sensing area 103R can be used, for example, in a surround view system.

A sensing area 104 represents an example of a sensing area of the LiDAR 53. The sensing area 104 covers up to a position farther than the sensing area 103F in front of the vehicle 1. On the other hand, the sensing area 104 has a narrower range in a left-right direction than the sensing area 103F.

Sensing results in the sensing area 104 are used, for example, to detect objects such as surrounding vehicles.

A sensing area 105 represents an example of a sensing area of the radar 52 for long distances. The sensing area 105 covers up to a position farther than the sensing area 104 in front of the vehicle 1. On the other hand, the sensing area 105 has a narrower range in the left-right direction than the sensing area 104.

The sensing results in the sensing area 105 are used, for example, for ACC (Adaptive Cruise Control), emergency braking, collision avoidance, and the like.

The sensing areas of the camera 51, the radar 52, the LiDAR 53, and the ultrasonic sensor 54 included in the external recognition sensor 25 may have various configurations other than those shown in FIG. 2. Specifically, the ultrasonic sensor 54 may be configured to sense the sides of the vehicle 1 or the LiDAR 53 may be configured to sense the rear of the vehicle 1. Moreover, the installation position of each sensor is not limited to each example mentioned above. Further, the number of sensors may be one or more than one.

### 2. Embodiments

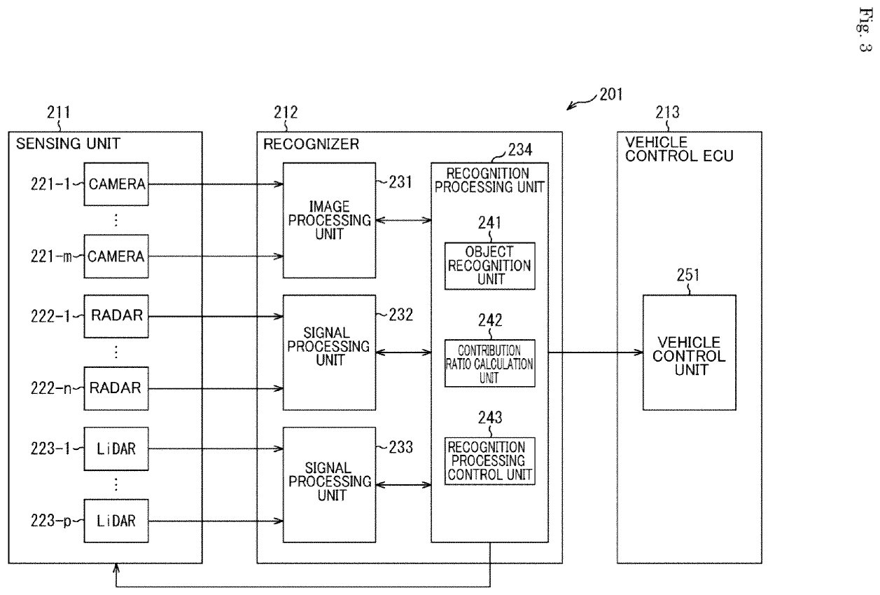

Next, embodiments of the present technology will be described with reference to FIGS. 3 to 9.

### Configuration Example of Information Processing System 201

FIG. 3 illustrates an exemplary configuration of an information processing system 201, showing a specific configuration example of the external recognition sensor 25, the vehicle control unit 32, the sensor fusion unit 72, and a part of the recognition unit 73 of the vehicle control system 11 in FIG. 1.

The information processing system 201 includes a sensing unit 211, a recognizer 212, and a vehicle control ECU 213.

The sensing unit 211 includes multiple types of sensors. For example, the sensing unit 211 includes cameras 221-1 to 221-m, radars 222-1 to 222-n, and LiDAR 223-1 to LiDAR 223-p.

Note that hereinafter, when it is not necessary to individually distinguish between the cameras 221-1 to 221-m, the cameras will be simply referred to as camera 221. Hereinafter, when it is not necessary to individually distinguish between the radars 222-1 to 222-n, the radars will be simply referred to as radar 222. Hereinafter, when it is not necessary to individually distinguish between the LiDAR 223-1 to LiDAR 223-p, the LiDARs will be simply referred to as LiDAR 223.

Each camera 221 performs sensing (imaging) around the vehicle 1 and supplies the captured image data, which is the acquired sensing data, to the image processing unit 231. The sensing range (imaging range) of each camera 221 may or may not overlap with the sensing range of other cameras 221.

Each radar 222 performs sensing around the vehicle 1 and supplies the acquired sensing data to the signal processing unit 232. The sensing range of each radar 222 may or may not overlap with the sensing range of other radars 222.

Each LiDAR 223 performs sensing around the vehicle 1 and supplies the acquired sensing data to the signal processing unit 233. The sensing range of each LiDAR 223 may or may not overlap with the sensing range of other LiDARs 223.

The three sensing ranges, i.e., the sensing range of the camera 221 as a whole, the sensing range of the radar 222 as a whole, and the sensing range of the LiDAR as a whole overlap at least partially.

Now, how each camera 221, each radar 222, and each LiDAR 223 perform sensing in the front of the vehicle 1 will be described.

The recognizer 212 executes recognition processing for objects in front of the vehicle 1 on the basis of image data captured by each camera 221, sensing data from each radar 222, and sensing data from each LiDAR 223. The recognizer 212 includes an image processing unit 231, a signal processing unit 232, a signal processing unit 233, and a recognition processing unit 234.

The image processing unit 231 performs prescribed image processing on the image data captured by each camera 221 to generate image data (hereinafter referred to as “captured image data for recognition”) to be used in the recognition processing unit 234 for object recognition processing.

Specifically, for example, the image processing unit 231 generates the captured image data for recognition by combining captured image data pieces. For example, the image processing unit 231 may also adjust the resolution of the captured image data for recognition as required, extract an area to be actually used for recognition processing from the captured image data for recognition, and perform color adjustment and white balance adjustment.

The image processing unit 231 supplies the captured image data for recognition to the recognition processing unit 234.

The signal processing unit 232 performs prescribed signal processing on the sensing data from each radar 222 to generate image data (hereinafter referred to as “laser image data for recognition”) to be used in the recognition processing unit 234 for object recognition.

Specifically, for example, the signal processing unit 232 generates radar image data, which is an image representing the sensing results of each radar 222, on the basis of the sensing data from the radar 222. For example, the signal processing unit 232 generates radar image data for recognition by combining pieces of radar image data. The signal processing unit 232 may also adjust the resolution of the radar image data for recognition as required, extract an area to be actually used for recognition processing from the radar image data for recognition, or perform FFT (Fast Fourier Transform) processing.

The signal processing unit 232 supplies the radar image data for recognition to the recognition processing unit 234.

The signal processing unit 233 performs prescribed signal processing on the sensing data from each LiDAR 223 to generate point cloud data (hereinafter referred to as “point cloud data for recognition”) to be used in the recognition processing unit 234 for object recognition processing.

Specifically, for example, the signal processing unit 233 generates point cloud data indicating sensing results from the LiDARs on the basis of sensing data from each LiDAR 223. The signal processing unit 233 combines pieces of point cloud data for recognition to generate point cloud data for recognition. For example, the signal processing unit 233 may, as required, adjust the resolution of the point cloud data for recognition or extract an area to be used for actual recognition processing from the point cloud data for recognition.

The signal processing unit 233 supplies the point cloud data for recognition to the recognition processing unit 234.

The recognition processing unit 234 performs object recognition processing in front of the vehicle 1 on the basis of the captured image data for recognition, the radar image data for recognition, and the point cloud data for recognition. The recognition processing unit 234 includes an object recognition unit 241, a contribution ratio calculation unit 242, and a recognition processing control unit 243.

The object recognition unit 241 performs object recognition processing in front of the vehicle 1 on the basis of the captured image data for recognition, the radar image data for recognition, and the point cloud data for recognition. The object recognition unit 241 supplies data indicating the results of the object recognition to the vehicle control unit 251.

Target objects to be recognized by the object recognition unit 241 may or may not be limited. If the target objects to be recognized by the object recognition unit 241 are limited, the type of objects to be recognized can be set arbitrarily. The number of types of objects to be recognized is not limited, and for example, the object recognition unit 241 may perform recognition processing for two or more types of objects.

The contribution ratio calculation unit 242 calculates the contribution ratio, which indicates the degree of contribution of each sensing data piece from each sensor of the sensing unit 211 to recognition processing by the object recognition unit 241.

The recognition processing control unit 243 controls the sensors of the sensing unit 211, the image processing unit 231, the signal processing unit 232, the signal processing unit 233, and the object recognition unit 241 on the basis of the contribution ratio of each sensing data piece to the recognition processing, thereby restricting the sensing data to be used for recognition processing.

The vehicle control ECU 213 implements the vehicle control unit 251 by executing a prescribed control program.

The vehicle control unit 251 corresponds, for example, to the vehicle control unit 32 in FIG. 1 and controls various parts of the vehicle 1. For example, the vehicle control unit 251 controls various parts of the vehicle 1 to avoid collisions with objects on the basis of the results of object recognition in front of the vehicle 1.

### Exemplary Configuration of Object Recognition Model 301

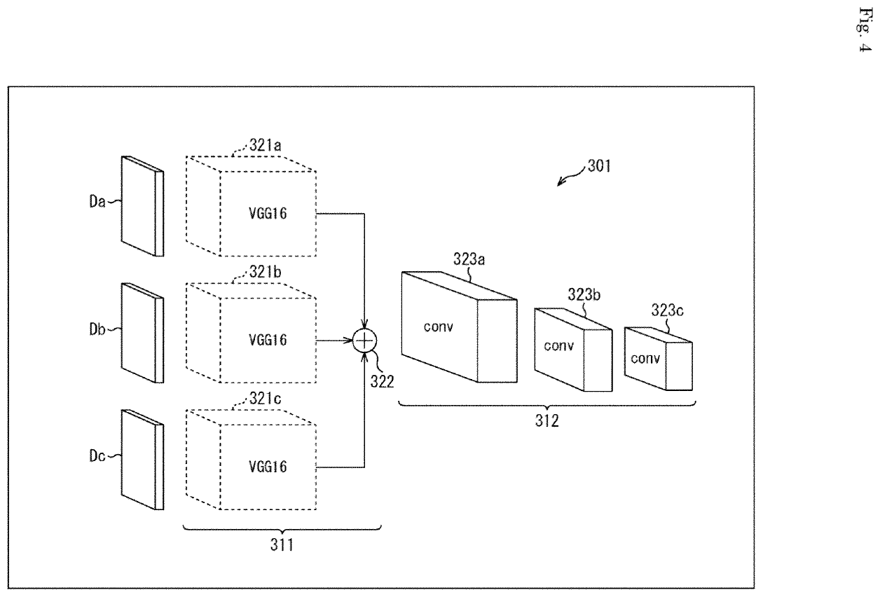

FIG. 4 shows an exemplary configuration of an object recognition model 301 used in the object recognition unit 241 in FIG. 3.

The object recognition model 301 is obtained by machine learning. Specifically, the object recognition model 301 utilizes a deep neural network and is a model obtained through deep learning, a type of machine learning. More specifically, the object recognition model 301 is configured using SSD (Single Shot Multibox Detector), which is one of the object recognition models that utilize a deep neural network. The object recognition model 301 includes a feature value extraction unit 311 and a recognition unit 312.

The feature value extraction unit 311 includes convolutional layers VGG16 321a to VGG16 321c, which use a convolutional neural network, and an addition unit 322.

The VGG16 321a extracts feature values from the captured image data for recognition Da supplied by the image processing unit 231, and generates a feature map (hereinafter referred to as “recognition image feature map”) that expresses the distribution of the feature values in two dimensions. The VGG16 321a supplies the recognition image feature map to the addition unit 322.

The VGG16 321b extracts feature values from the radar image data for recognition Db supplied from the signal processing unit 232, and generates a feature map (hereinafter referred to as radar image feature map) that expresses the distribution of feature values in two dimensions. The VGG16 321b supplies the radar image feature map to the addition unit 322.

The VGG16 321c extracts feature values from the point cloud data for recognition Dc supplied from the signal processing unit 233, and generates a feature map (hereinafter referred to as point cloud data feature map) that expresses the distribution of feature values in two dimensions. The VGG16 321c supplies the point cloud data feature map to the addition unit 322.

The addition unit 322 generates a combined feature map by adding the captured image feature map, the radar image feature map, and the point cloud data feature map. The addition unit 322 supplies the combined feature map to the recognition unit 312.

The recognition unit 312 includes a convolutional neural network. Specifically, the recognition unit 312 includes convolutional layers 323a to 323c.

The convolutional layer 323a performs convolution operation on the combined feature map. The convolutional layer 323a performs object recognition processing on the basis of the combined feature map after the convolution operation. The convolutional layer 323a supplies the combined feature map after the convolution operation to the convolutional layer 323b.

The convolutional layer 323b performs the convolutional operation on the combined feature map supplied from the convolutional layer 323a. The convolutional layer 323b performs object recognition processing on the basis of the combined feature map after the convolution operation. The convolutional layer 323b supplies the combined feature map after the convolution operation to the convolutional layer 323c.

The convolutional layer 323c performs convolutional operation on the combined feature map supplied from the convolutional layer 323b. The convolutional layer 323c performs object recognition processing on the basis of the combined feature map after the convolutional operation.

The object recognition model 301 supplies data indicating the results of object recognition by the convolutional layers 323a to 323c to the vehicle control unit 251.

The size (number of pixels) of the combined feature map decreases in order from the convolutional layer 323a, reaching its smallest size at the convolutional layer 323c. As the size of the combined feature map increases, the accuracy in recognizing objects that are smaller in size as seen from vehicle 1 increases, and as the size of the combined feature map decreases, the accuracy in recognizing objects that are larger in size as seen from vehicle 1 increases. Therefore, when, for example, the object to be recognized is a vehicle, a larger combined feature map makes it easier to recognize distant vehicles that appear small, while a smaller combined feature map makes it easier to recognize nearby vehicles that appear large.

### Object Recognition Processing According to First Embodiment

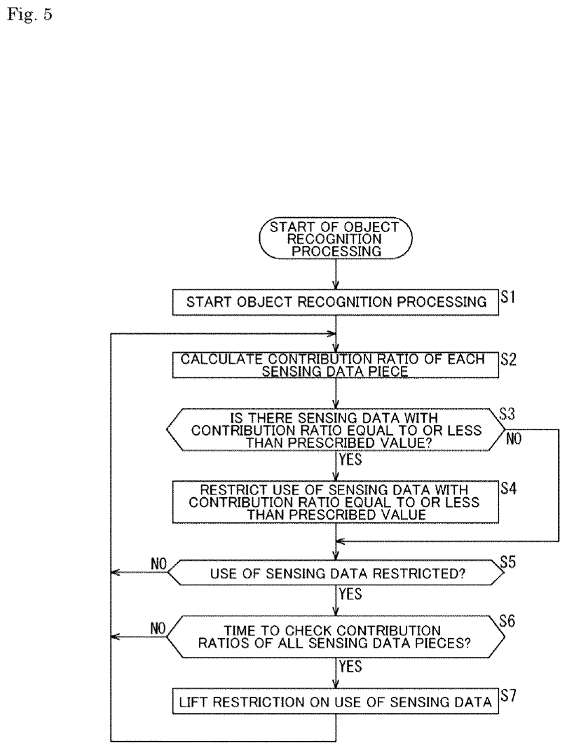

With reference to the flowchart in FIG. 5, object recognition processing performed by the information processing system 201 according to a first embodiment will be described.

In step S1, the information processing system 201 starts the object recognition processing. For example, the following process is started.

Each camera 221 captures images in front of the vehicle 1 and supplies the captured image data to the image processing unit 231. The image processing unit 231 generates captured image data for recognition on the basis of the captured image data from each camera 221 and supplies the data to the VGG16 321a. The VGG16 321a extracts feature values from the captured image data for recognition, generates a captured image feature map, and supplies the map to the addition unit 322.

Each radar 222 performs sensing in front of the vehicle 1 and supplies the acquired sensing data to the signal processing unit 232. The signal processing unit 232 generates radar image data for recognition on the basis of the sensing data from each radar 222 and supplies the data to the VGG16 321b. The VGG16 321b extracts feature values from the radar image data for recognition, generates a radar image feature map, and supplies the map to the addition unit 322.

Each LiDAR 223 performs sensing in front of the vehicle 1 and supplies the acquired sensing data to the signal processing unit 233. The signal processing unit 233 generates point cloud data for recognition on the basis of the sensing data from each LiDAR 223 and supplies the data to the VGG16 321c. The VGG16 321c extracts feature values from the point cloud data for recognition, generates a point cloud data feature map, and supplies the map to the addition unit 322.

The addition unit 322 generates a combined feature map by adding the captured image feature map, the radar image feature map, and the point cloud data feature map, and supplies the resulting map to the convolutional layer 323a.

The convolutional layer 323a performs convolutional operation on the combined feature map and performs object recognition processing on the basis of the combined feature map after the convolutional operation. The convolutional layer 323a supplies the combined feature map after the convolutional operation to the convolutional layer 323b.

The convolutional layer 323b performs convolution operation on the combined feature map supplied from the convolutional layer 323a and performs object recognition processing on the basis of the combined feature map after the convolution operation. The convolutional layer 323b supplies the combined feature map after the convolution operation to the convolutional layer 323c.

The convolutional layer 323c performs the convolutional operation on the combined feature map supplied from the convolutional layer 323b and execute object recognition processing on the basis of the combined feature map after the convolutional operation.

The object recognition model 301 supplies data indicating the results of object recognition by the convolutional layer 323a to the convolutional layer 323c to the vehicle control unit 251.

In step S2, the contribution ratio calculation unit 242 calculates the contribution ratio of each sensing data piece. For example, the contribution ratio calculation unit 242 calculates the ratios of contribution of the captured image feature map, the radar image feature map, and the point cloud data feature map included in the combined feature map to the object recognition processing by the recognition unit 312 (the convolutional layers 323a to 323c).

The method for calculating the contribution ratio is not particularly limited, and any method can be used.

In step S3, the contribution ratio calculation unit 242 determines whether there is sensing data with a contribution ratio equal to or less than a prescribed value. For example, upon determining that there is a feature map with a contribution ratio equal to or less than a prescribed value among the captured image feature map, the radar image feature map, and the point cloud data feature map, the contribution ratio calculation unit 242 determines that there is sensing data with a contribution ratio equal to or less than the prescribed value, and the process proceeds to step S4.

In step S4, the information processing system 201 restricts the use of sensing data with a contribution ratio equal to or less than the prescribed value.

If, for example, the contribution ratio of the captured image feature map is equal to or less than a prescribed value, the recognition processing control unit 243 restricts the use of the captured image data, which is the sensing data corresponding to the captured image feature map, in the recognition processing. For example, the recognition processing control unit 243 restricts the use of the captured image data in the recognition processing by executing one or more of the following types of processing.

For example, the recognition processing control unit 243 restricts the processing of each camera 221. For example, the recognition processing control unit 243 may stop the shooting of each camera 221, reduce the frame rate of each camera 221, or lower the resolution of each camera 221.

For example, the recognition processing control unit 243 stops the processing of the image processing unit 231.

For example, the image processing unit 231 lowers the resolution of the captured image data for recognition under the control of the recognition processing control unit 243. In this case, the resolution may be lowered only in a limited area.

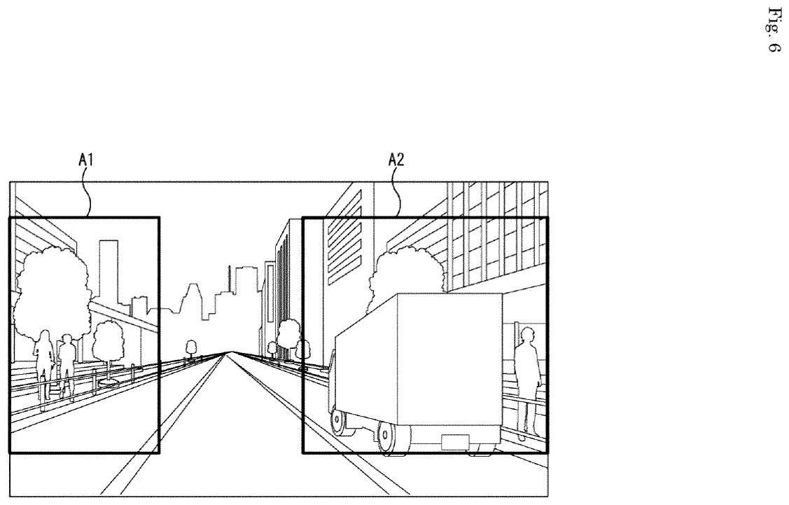

For example, FIG. 6 shows an example of captured image data for recognition when the vehicle 1 travels through an urban area. In this example, there is no preceding vehicle in front of the vehicle 1, and the recognition processing in the areas A1 and A2, where the risk of a pedestrian suddenly darting out is high, is critical. In response, the image processing unit 231 lowers the resolution of the areas other than the areas A1 and A2 in the captured image data for recognition, as these areas have a low contribution to the recognition processing.

For example, the VGG16 321a restricts a target area for recognition processing (the area from which feature values are extracted) in the captured image data for recognition under the control of the recognition processing control unit 243.

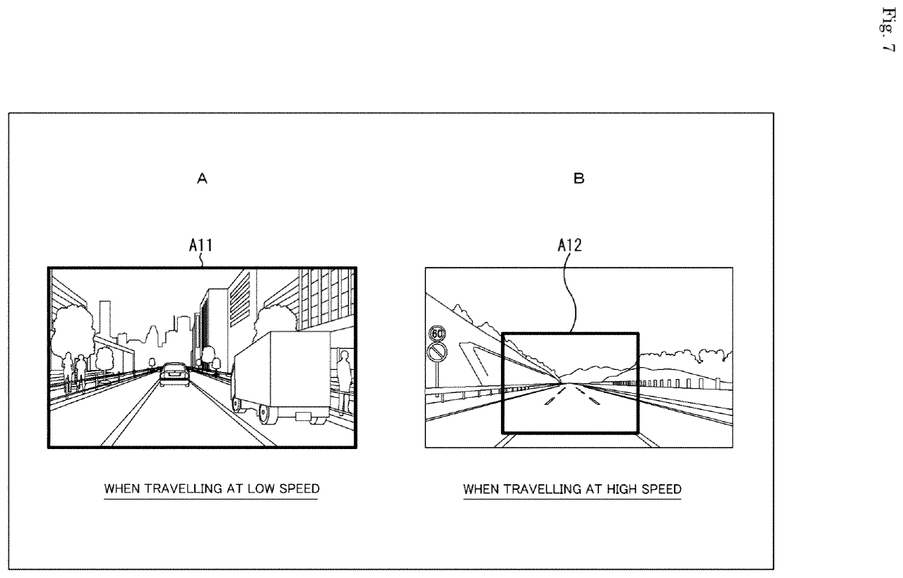

For example, FIG. 7 shows an example of captured image data for recognition. Specifically, FIG. 7 at A shows an example of captured image data for recognition when the vehicle 1 travels at low speed in an urban area. FIG. 7 at B shows an example of captured image data for recognition when the vehicle 1 travels at high speed in a suburban area.

For example, in the example in FIG. 7 at A, the entire area All of the captured image data for recognition is set as the ROI (Region of Interest) so that it can respond to objects that suddenly burst out. Then, recognition processing is performed on region A11.

In the example in FIG. 7 at B, because the vehicle 1 travels at high speed, it is difficult to respond to objects that suddenly burst out in front of the vehicle. Therefore, the area A12 near the center of the captured image data for recognition is set as the ROI. Then, recognition processing is executed for the area A12.

Similarly, if, for example, the contribution ratio of the radar image feature map is equal to or less than a prescribed value, the recognition processing control unit 243 restricts the use of the radar image data, which is the sensing data corresponding to the radar image feature map, in the recognition processing. For example, the recognition processing control unit 243 restricts the use of the radar image data for recognition processing by executing one or more of the following types of processing.

For example, the recognition processing control unit 243 restricts the processing of each radar 222. For example, the recognition processing control unit 243 stops the sensing of each radar 222, lowers the frame rate (e.g., scanning speed) of each radar 222, or lowers the resolution (e.g., sampling density) of each radar 222.

For example, the recognition processing control unit 243 stops the processing of the signal processing unit 232.

For example, the signal processing unit 232 lowers the resolution of the radar image data for recognition under the control of the recognition processing control unit 243. In this case, the resolution may be lowered only in a limited area.

For example, the VGG16 321b restricts the target area for recognition processing (the area from which feature values are extracted) in the radar image data for recognition under the control of the recognition processing control unit 243.

Similarly, if, for example, the contribution ratio of the point cloud data feature map is equal to or less than a prescribed value, the recognition processing control unit 243 restricts the use of the point cloud data, which is the sensing data corresponding to the point cloud data feature map, in the recognition processing. For example, the recognition processing control unit 243 restricts the use of the point cloud data in the recognition processing by executing one or more of the following types of processing.

For example, the recognition processing control unit 243 restricts the processing of each LiDAR 223. For example, the recognition processing control unit 243 stops the sensing of each LiDAR 223, lowers the frame rate (e.g., scanning speed) of each LiDAR 223, or lowers the resolution (e.g., sampling density) of each LiDAR 223.

For example, the recognition processing control unit 243 stops the processing of the signal processing unit 233.

For example, the signal processing unit 233 lowers the resolution of the point cloud data under the control of the recognition processing control unit 243. In this case, the resolution may be lowered only in a limited area.

For example, the VGG16 321c restricts the target area for recognition processing (the area from which feature values are extracted) in the point cloud data for recognition under the control of the recognition processing control unit 243.

Thereafter, the process proceeds to step S5.

Meanwhile, if it is determined in step S3 that there is no sensing data with a contribution ratio equal to or less than the prescribed value, the processing in step S4 is skipped, and the process proceeds to step S5.

In step S5, the recognition processing control unit 243 determines whether the use of the sensing data is restricted. If it is determined that the use of the sensing data is not restricted, in other words, if all the sensing data pieces are used in the recognition processing without restriction, the process returns to step S2.

Then, the processing from step S2 onwards is executed.

Meanwhile, if it is determined in step S5 that the use of the sensing data is restricted, in other words, if the use of part of the sensing data in the recognition processing is restricted, the process proceeds to step S6.

In step S6, the recognition processing control unit 243 determines whether it is time to determine the contribution ratios of all the sensing data pieces.

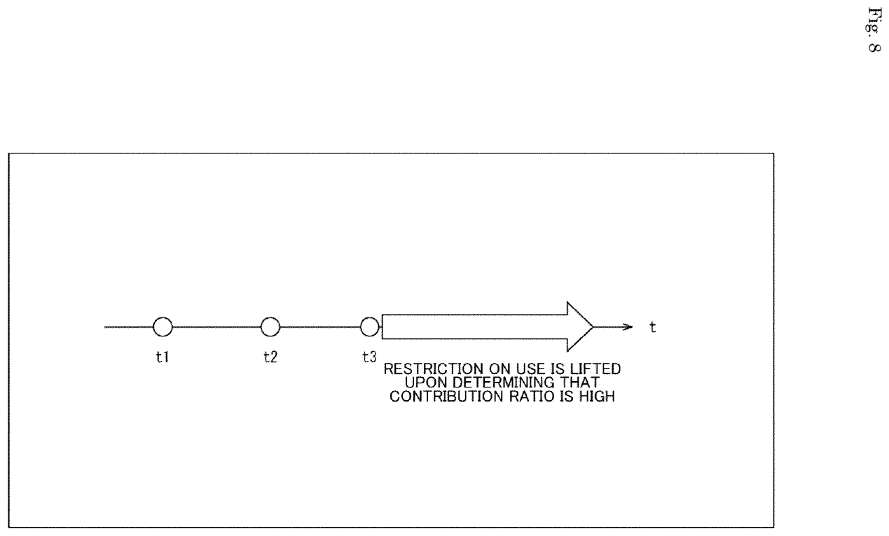

If, for example, the use of sensing data is restricted, as shown in FIG. 8, the contribution ratios of all the sensing data pieces including the sensing data, the use of which is restricted, to recognition processing are checked at prescribed timing. In this example, the contribution ratios of all the sensing data pieces to recognition processing are checked at time t1, t2, t3, . . . at prescribed time intervals.

Then, if it is determined in step S6 that it is not time to check the contribution ratios of all the sensing data pieces, the process returns to step S2.

Thereafter, the processing from step S2 onwards is performed.

Meanwhile, if it is determined in step S6 that it is time to check the contribution ratios of all sensing data, the process proceeds to step S7.

In step S7, the recognition processing control unit 243 lifts the restriction on the use of sensing data. In other words, the recognition processing control unit 243 temporarily lifts the restriction on the use of the sensing data with a contribution ratio equal to or less than the prescribed value in the recognition processing performed in the processing in step S4.

Thereafter, the process returns to step S2 and the processing from step S2 onwards is performed.

If, for example, it is determined in step S3 that the contribution ratio of the sensing data, the use of which is restricted, is high (the contribution ratio exceeds a prescribed threshold), the restriction on the use of the sensing data is lifted from that point on. If, for example, it is determined at time t3 in FIG. 8 that the contribution ratio of the sensing data, the use of which is restricted, is high, the restriction on the use of the sensing data is lifted from time t3 onwards.

In this way, the use of sensing data with a low contribution ratio in recognition processing is restricted, so that the power consumption by the object recognition processing using sensor fusion processing is reduced. This allows the driving distance of the vehicle 1 to be increased.

### Object Recognition Processing According to Second Embodiment

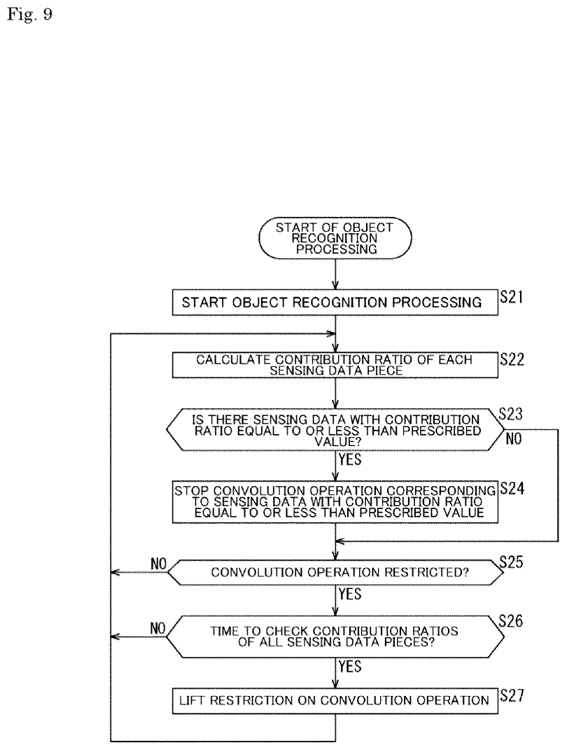

Next, with reference to the flowchart in FIG. 9, object recognition processing according to a second embodiment will be described.

In step S21, object recognition processing starts similarly to the processing in step S1 in FIG. 5.

In step S22, the contribution ratio of each piece of sensing data is calculated similarly to the processing in step S2 in FIG. 5.

It is determined in step S23 whether there is sensing data with a contribution ratio equal to or less than a prescribed value, similarly to the processing in step S3 in FIG. 5. If it is determined that there is sensing data with a contribution ratio equal to or less than the prescribed value, the process proceeds to step S24.

In step S24, the information processing system 201 stops convolution operation corresponding to the sensing data with a contribution ratio equal to or less than the prescribed value.

If, for example, the contribution ratio of the captured image feature map is equal to or less than the prescribed value, the recognition processing control unit 243 stops convolution operation corresponding to the captured image data, which is the sensing data corresponding to the captured image feature map.

Specifically, for example, the recognition processing control unit 243 stops the processing of the VGG16 321a (processing for generating the captured image feature map). Alternatively, for example, the recognition processing control unit 243 causes the addition unit 322 to stop adding the captured image feature map.

If, for example, the contribution ratio of the radar image feature map is equal to or less than a prescribed value, the recognition processing control unit 243 stops convolution operation corresponding to the radar image data, which is the sensing data corresponding to the radar image feature map.

Specifically, for example, the recognition processing control unit 243 stops the processing of the VGG16 321b (processing for generating the radar image feature map). Alternatively, for example, the recognition processing control unit 243 causes the addition unit 322 to stop adding the radar image feature map.

If, for example, the contribution ratio of the point cloud data feature map is equal to or less than the prescribed value, the recognition processing control unit 243 stops the convolution operation corresponding to the point cloud data, which is the sensing data corresponding to the point cloud data feature map.

Specifically, for example, the recognition processing control unit 243 stops the processing of the VGG16 321c (processing for generating the point cloud data feature map). Alternatively, for example, the recognition processing control unit 243 causes the addition unit 322 to stop adding the point cloud data feature map.

Thereafter, the process proceeds to step S25.

Meanwhile, if it is determined in step S23 that there is no sensing data with a contribution ratio equal to less than the prescribed value, the processing in step S24 is skipped, and the process proceeds to step S25.

In step S25, the recognition processing control unit 243 determines whether convolution operation is restricted. If there is no sensing data, on which the convolution operation has been stopped, the recognition processing control unit 243 determines that the convolution operation is not restricted, and the process returns to step S22.

Thereafter, the processing in step S22 onwards is performed. Meanwhile, in step S25, if there is sensing data, on which the convolution operation has been stopped, the recognition processing control unit 243 determines that the convolution operation is restricted, and the process proceeds to step S26.

In step S26, it is determined whether it is time to check the contribution ratios of all sensing data, similarly to the processing in step S6 in FIG. 5. If it is determined that it is not time to check the contribution ratios of all sensing data, the process returns to step S22.

Thereafter, the processing step S22 onwards is performed.

Meanwhile, if it is determined in step S26 that it is time to check the contribution ratios of all sensing data, the process proceeds to step S27.

In step S27, the recognition processing control unit 243 lifts the restriction on the convolution operation. In other words, the recognition processing control unit 243 temporarily resumes the convolution operation corresponding to the sensing data, on which the convolution operation has been stopped.

Thereafter, the process returns to step S22, and the processing from step S22 onwards is executed. If, for example, it is determined in step S23 that the contribution ratio of the sensing data, on which the convolution operation has been stopped, is high (if the contribution ratio exceeds the prescribed threshold), the stopping of the convolution operation on the sensing data is lifted from that point onwards.

In this way, the convolution operation on sensing data with a low contribution ratio is stopped, so that the power consumption by the object recognition processing using sensor fusion processing is reduced. This allows the driving distance of the vehicle 1 to be increased.

### 3. Modifications

Hereinafter, modifications of the foregoing embodiments of the present technology will be described.

For example, the object recognition processing in FIG. 5 and the object recognition processing in FIG. 9 may be executed simultaneously. Specifically, for example, the restriction on the use of sensing data with a contribution ratio equal to or less than a prescribed value in the recognition processing and the stopping of the convolution operation corresponding to the sensing data may be executed simultaneously.

For example, the contribution ratio calculation unit 242 may calculate the contribution ratio of each piece of sensing data of the same type individually, and the recognition processing control unit 243 may restrict the use of each piece of sensing data of the same type for recognition processing individually.

Specifically, for example, the contribution ratio calculation unit 242 may calculate the contribution ratio of each captured image data piece individually, and the recognition processing control unit 243 may restrict the use of each captured image data piece for recognition processing individually. For example, among the cameras 221, only cameras 221 used to capture the captured image data, for which the contribution ratio is determined to be equal to or less than a prescribed value, may be stopped.

For example, the combination of sensors used for sensor fusion processing can be changed as appropriate. For example, ultrasonic sensors may also be used. For example, only two or three types of sensors among the camera 221, the radar 222, the LiDAR 223, and the ultrasonic sensors may be used. For example, the number of sensors does not necessarily have to be plurality and may be one.

In the foregoing description, the object recognition processing in front of vehicle 1 is performed using sensor fusion processing by way of illustration, but the present technology can also be applied to cases where the object recognition processing is performed in other directions around the vehicle 1.

The present technology can also be applied to mobile objects other than vehicles that perform sensor fusion processing.

### 4. Others

### Configuration Example of Computer

The series of processing described above can be executed by hardware or software. When executing the series of processing via software, the program that constitutes the software is installed on the computer. Here, the computer includes for example a computer embedded in dedicated hardware or a general-purpose personal computer capable of executing various functions by installing various programs.

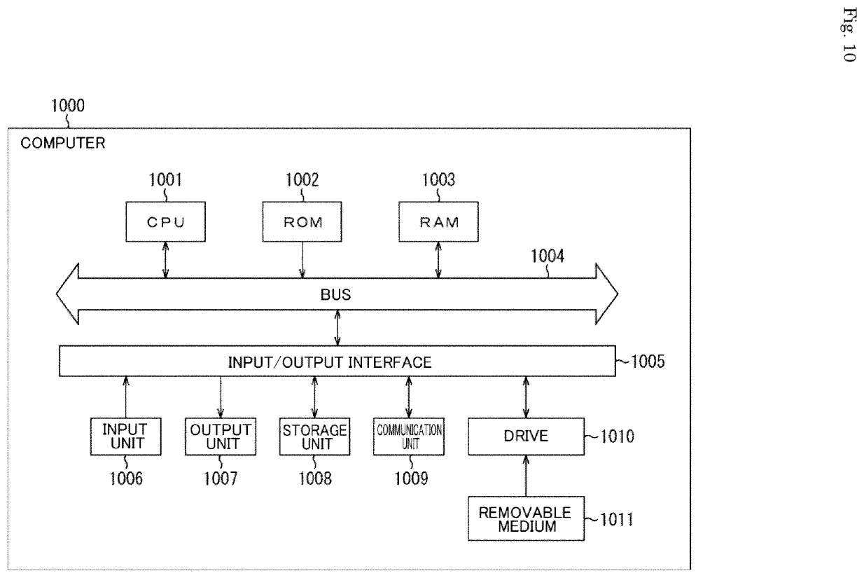

FIG. 10 is a block diagram showing an example of a hardware configuration of a computer that executes the above-described series of processing according to a program.

In a computer 1000, a CPU (central processing unit) 1001, a ROM (read only memory) 1002, and a RAM (random access memory) 1003 are connected to each other by a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes for example an input switch, a button, a microphone, and an imaging element. The output unit 1007 includes for example a display and a speaker. The storage unit 1008 includes for example a hard disk and a non-volatile memory. The communication unit 1009 may be a network interface. The drive 1010 drives a removable medium 1011 such as a magnetic disk, an optical disc, a magneto-optical disk, or a semiconductor memory.

In the computer 1000 configured as described above, for example, the CPU 1001 loads a program recorded in the storage unit 1008 into the RAM 1003 via the input/output interface 1005 and the bus 1004 and executes the program to perform the above-described series of processing.

The program executed by the computer 1000 (CPU 1001) may be recorded for example on the removable medium 1011 for example as a package medium so as to be provided. The program can also be provided via a wired or wireless transmission medium such as a local area network, the Internet, or digital satellite broadcasting.

In the computer 1000, the program may be installed in the storage unit 1008 via the input/output interface 1005 by inserting the removable medium 1011 into the drive 1010. Further, the program can be received by the communication unit 1009 via the wired or wireless transmission medium and installed in the storage unit 1008. Alternatively, the program can be installed in the ROM 1002 or the storage unit 1008 in advance.

Note that the program executed by a computer may be a program that performs processing in time series in order described in the present specification or may be a program that performs processing in parallel or at a necessary timing such as when a called is made.

In the present specification, a system means a set of a plurality of constituent elements (devices, modules (components), or the like) and all the constituent elements may or may not be included in a same casing. Accordingly, a plurality of devices accommodated in separate casings and connected via a network and one device in which a plurality of modules are accommodated in one casing both constitute systems.

Further, embodiments of the present technology are not limited to the above-mentioned embodiments and various modifications may be made without departing from the gist of the present technology.

For example, the present technology may have a cloud computing configuration where a single function is shared and processed in cooperation by multiple devices over a network.

In addition, each step described in the above flowchart can be executed by one device or executed in a shared manner by multiple devices.

Furthermore, when a single step includes multiple kinds of processing, the multiple kinds of processing included in the single step can be executed by one device or by multiple devices in a shared manner.

### Configuration Combination Example

The present technology can also have the following configuration.

(1)

An information processing device, comprising:
an object recognition unit configured to combine sensing data pieces from multiple types of sensors that perform sensing around a vehicle so as to perform object recognition processing;
a contribution ratio calculation unit configured to calculate a contribution ratio of each of the sensing data pieces in the recognition processing; and
a recognition processing control unit configured to restrict the sensing data pieces to be used for the recognition processing on the basis of the contribution ratio.

(2)

The information processing device according to (1), wherein the recognition processing control unit is configured to restrict use of low contribution ratio sensing data which is the sensing data with the contribution ratio equal to or less than a prescribed threshold value in the recognition processing.

(3)

The information processing device according to (2), wherein the recognition processing control unit is configured to restrict processing by a low contribution ratio sensor which is the sensor corresponding to the low contribution ratio sensing data.

(4)

The information processing device according to (3), wherein the recognition processing control unit stops sensing by the low contribution ratio sensor.

(5)

The information processing device according to (3) or (4), wherein the recognition processing control unit lowers at least one of a frame rate and resolution of the low contribution ratio sensor.

(6)

The information processing device according to any one of (2) to (5), wherein the recognition processing control unit lowers resolution of the low contribution ratio sensing data.

(7)

The information processing device according to any one of (2) to (6), wherein the recognition processing control unit restricts an area to be subjected to the recognition processing in the low contribution ratio sensing data.

(8)

The information processing device according to any one of (2) to (7), wherein the object recognition unit performs the recognition processing using an object recognition model using a convolutional neural network, and
the recognition processing control unit stops convolution operation corresponding to the low contribution ratio sensing data.

(9)

The information processing device according to any one of (2) to (8), wherein the recognition processing control unit lifts restriction on use of the low contribution ratio sensing data for the recognition processing at prescribed time intervals.

(10)

The information processing device according to any one of (1) to (9), wherein the multiple types of sensors include at least two of a camera, a LiDAR, a radar, and an ultrasonic sensor.

(11)

An image processing method comprising:
combining sensing data pieces from multiple types of sensors that perform sensing around a vehicle, thereby performing object recognition processing;
calculating a contribution ratio of each of the sensing data pieces to the recognition processing; and
restricting the sensing data pieces to be used for the recognition processing on the basis of the contribution ratio.

(12)

An information processing system, comprising:
multiple types of sensors configured to perform sensing around a vehicle; an object recognition unit configured to combine sensing data pieces from the respective sensors so as to perform object recognition processing;
a contribution ratio calculation unit configured to calculate a contribution ratio of each of the sensing data pieces to the recognition processing; and
a recognition processing control unit configured to restrict the sensing data pieces to be used for the recognition processing on the basis of the contribution ratio.

The advantageous effects described in the present specification are merely exemplary and are not limited, and other advantageous effects may be obtained.

### REFERENCE SIGNS LIST

1 Vehicle
11 Vehicle control system
25 External recognition sensor
32 Vehicle control unit
72 Sensor fusion unit
73 Recognition unit
211 Sensing unit
212 Recognizer
213 Vehicle control ECU
221-1 to 221-m Camera
222-1 to 222-n Radar
223-1 to 223-p LiDAR
231 Image processing unit
232, 233 Signal processing unit
234 Recognition processing unit
241 Object recognition unit
242 Contribution ratio calculation unit
243 Recognition processing control unit
251 Vehicle control unit
301 Object recognition model
311 Feature value extraction unit
312 Recognition unit
321a to 321c VGG16
322 Addition unit
323a to 323c Convolutional layer

1. An information processing device, comprising:
an object recognition unit configured to combine sensing data pieces from multiple types of sensors that perform sensing around a vehicle so as to perform object recognition processing;
a contribution ratio calculation unit configured to calculate a contribution ratio of each of the sensing data pieces in the recognition processing; and
a recognition processing control unit configured to restrict the sensing data pieces to be used for the recognition processing on the basis of the contribution ratio.

2. The information processing device according to claim 1, wherein the recognition processing control unit is configured to restrict use of low contribution ratio sensing data which is the sensing data with the contribution ratio equal to or less than a prescribed threshold value in the recognition processing.

3. The information processing device according to claim 2, wherein the recognition processing control unit is configured to restrict processing by a low contribution ratio sensor which is the sensor corresponding to the low contribution ratio sensing data.

4. The information processing device according to claim 3, wherein the recognition processing control unit stops sensing by the low contribution ratio sensor.

5. The information processing device according to claim 3, wherein the recognition processing control unit lowers at least one of a frame rate and resolution of the low contribution ratio sensor.

6. The information processing device according to claim 2, wherein the recognition processing control unit lowers resolution of the low contribution ratio sensing data.

7. The information processing device according to claim 2, wherein the recognition processing control unit restricts an area to be subjected to the recognition processing in the low contribution ratio sensing data.

8. The information processing device according to claim 2, wherein the object recognition unit performs the recognition processing using an object recognition model using a convolutional neural network, and
the recognition processing control unit stops convolution operation corresponding to the low contribution ratio sensing data.

9. The information processing device according to claim 2, wherein the recognition processing control unit lifts restriction on use of the low contribution ratio sensing data for the recognition processing at prescribed time intervals.

10. The information processing device according to claim 1, wherein the multiple types of sensors include at least two of a camera, a LiDAR, a radar, and an ultrasonic sensor.

11. An image processing method comprising:
combining sensing data pieces from multiple types of sensors that perform sensing around a vehicle, thereby performing object recognition processing;
calculating a contribution ratio of each of the sensing data pieces in the recognition processing; and
restricting the sensing data pieces to be used for the recognition processing on the basis of the contribution ratio.

12. An information processing system, comprising:
multiple types of sensors configured to perform sensing around a vehicle;
an object recognition unit configured to combine sensing data pieces from the respective sensors and perform object recognition processing;
a contribution ratio calculation unit configured to calculate a contribution ratio of each of the sensing data pieces in the recognition processing; and
a recognition processing control unit configured to restrict the sensing data pieces to be used for the recognition processing on the basis of the contribution ratio.
